(19) United States
(12) Patent Application Publication
(10) Pub. No.: US 2005/0042411 A1
(43) Pub. Date: Feb. 24, 2005

(54) Neuro musculare developing care

(76) Inventor: Carinn Alluna, Melby (DK)

Correspondence Address: JACOBSON HOLMAN PLLC, 400 SEVENTH STREET N.W., SUITE 600, WASHINGTON, DC, 20004, US

(21) Appl. No.: 10/490,747

(22) PCT Filed: Oct. 10, 2002
(86) PCT No.: PCT/DK02/00680

(30) Foreign Application Priority Data
Oct. 12, 2001 (DK) PA 2001 01507

(51) Int. Cl. B32B 3/02

(52) U.S. Cl. 428/80

(57) ABSTRACT

NMD Care for premature infants to be used primarily at the neonatal stage in incubators, cradles or in connection with light therapy. NMD Care is flexible and contains water. NMD Care embraces all or part of the premature infant's head and body while the infant is in the prone or lateral position. In mature neonatal infants, the muscles that cause flexure are stronger and more dominant than the extensors. In premature neonatal infants, the general muscular tone and sensory capabilities are at a development level that is receptive to impulses from the uterus environment, corresponding to the infant's gestation age. Using NMD Care for premature neonatal infants gives the infant an opportunity to continue developing its psycho-motor skills in an environment closely resembling that which could be expected considering the infant's gestation age. Embracing the premature infant with the NMD Care helps stimulate its tactile and vestibular senses. Stimulation is characterised in part by the constant contact and in part by the water's response to the infant's movements as well as by the movement transmitted through the water, resulting in a more global stimulation of the infant via the contact between the inside of the NMD Care and the infant's body. The proprioceptive sense and muscular tone are also stimulated, as NMD Care provides flexible resistance to any extension, causing the infant to return to a flexed position after reflex extension. The above-mentioned affects the infant's perception of itself both in terms of motor skills (physiological and sensory) and psychologically (emotionally and socially) later in life. NMD Care is hygienic, reusable and easy to move when used to nurse premature infants.

This invention concerns neomuscular developing care for premature infants to be used primarily at the neonatal stage.

The Neomuscular Developing Care embraces the infant to keep it in a flexed position, despite reflex extension. The stimulation provided by the NMD Care helps the infant develop its motor pattern in a process parallel to the development it would have undergone in the foetal state.

Neonatal units commonly place a rolled up napkin, towel or the like close to the premature infant to provide comfort.

NMD Care contains water in an enclosed chamber. NMD Care is also flexible, allowing it to embrace all or part of the premature infant's body, whether in a prone or lateral position.

The invention is explained in detail in the following with references to the illustrations:

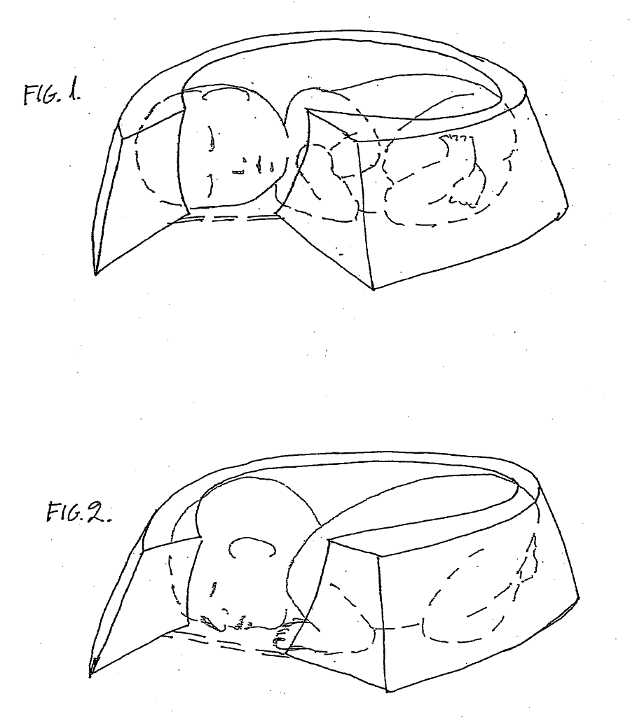

FIG. 1 shows how NMD Care embraces the infant while in a lateral position

FIG. 2 shows how NMD Care embraces the infant while in a prone position

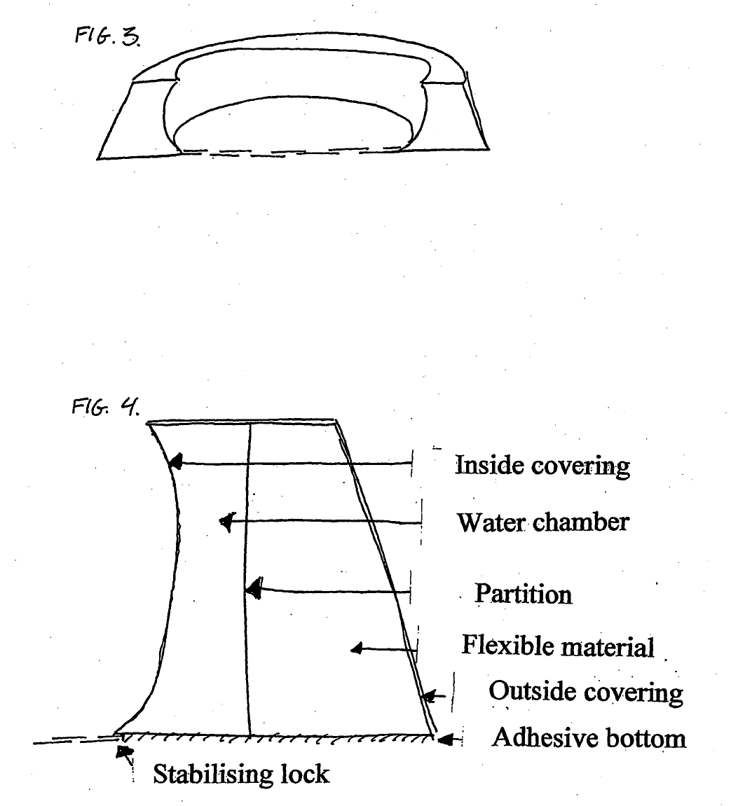

FIG. 3 shows NMD Care before use

FIG. 4 shows a cross-section of NMD Care

FIG. 1 shows how NMD Care embraces the infant while in a lateral position. It allows some extension, after which the extremities will be brought back to a flexed position. This ensures some development of the nerve supply of the striated musculature, some development of the part of the brain that controls the basic motor skills as well as some exercise of the musculature.

Extension of the extremities will encounter accommodating resistance from the NMD Care's water chamber. The water transmits movements, thus providing tactile stimulation of the infant in a continuous movement through the NMD Care's general contact with the infant's body.

FIG. 2 shows how NMD Care embraces the infant while in a prone position with its arms and legs tugged under its body. The illustration also shows the height of NMD Care and thus the size of the contact surface to the infant.

In addition to the above-mentioned physiological effect, NMD Care's embrace gives the infant the sensation of comfort. In the long run, this psychological effect will have a positive impact on personality development.

FIG. 3 shows NMD Care in its entirety before use. NMD Care can be cleaned, formed as needed and reused.

NMD Care is shaped like a capital C with an even and uniform shape and thickness.

FIG. 4 shows a cross-section of NMD Care.

The inside of NMD Care is concave, allowing it to shape around the infant. The outside slopes slightly away from the infant, further enforcing and stabilising the NMD Care, its height being equal to that of the infant.

The outer layer is a vinyl covering that can be cleaned. The quality of the vinyl covering used for the concave inside, outside, top and bottom of NMD Care varies in terms of firmness, as the concave inside, outside, top and bottom serve different functions in relation to the infant. The bottom also has an adhesive property.

Furthermore, NMD Care has a locking unit under its end surfaces to stabilise it in a shape that fits the individual infant and to resist pressure from the extension of the extremities.

Internally, NMD Care is divided into two chambers. The chamber facing the infant's body contains water. The second chamber contains a flexible material enabling the module to be shaped around the infant, while providing stability and resistance in connection with extension.

1. Neomuscular Developing Care for premature infants to be used primarily at the neonatal stage in incubators, cradles and in connection with light therapy is characterised by its concave inside, slightly sloping outside, its flat top and bottom, its height, corresponding to the height of the infant, its length, corresponding to the circumference of the infant's body as well as its division into two longitudinal chambers.

2. In accordance with claim 1, Neomuscular Developing Care is characterised by having a locking unit on the bottom.

3. In accordance with claim 1, Neomuscular Developing Care is characterised by the different vinyl surfaces on the inside, top and outside as well as on the bottom, which also has an adhesive property, and the material of the two chambers, water and a flexible, stabilising material, respectively.

4. A device for positioning a prematurely born infant in a bent position, said device comprising a cushioning part defining a space having the shape of a bent prematurely born infant and wherein the cushioning part comprises a chamber having a flexible wall on the side facing said space, characterized in that said chamber is filled with a medium capable of providing tactile stimulation of the infant in a continuous movement through said flexible wall.

5. A device according to claim 4, characterized in that the cushioning part comprises an inner chamber and an outer chamber.

6. A device according to claim 5, characterized in that the outer chamber is filled with a flexible material.

7. A device according to claim 4, characterized in that the device further comprises a covering.

8. A device according to claim 4, characterized in that a different vinyl covering are used on the inside, the top and the outside surfaces.

9. A device according to claim 4, characterized in that the device further comprises a locking unit.

10. A device according to claim 4, characterized in that the device further comprises a bottom part.

11. A device according to claim 10, characterized in that the bottom part has adhesive properties.

12. A device according to claim 4, characterized in that the medium is a flowable medium.

13. A device according to claim 4, characterized in that the medium is a liquid medium.

14. A device according to claim 4, characterized in that the medium is an aqueous medium.

15. A device according to claim 4, characterized in that the medium is water.

16. A device according to claim 4, characterized in that the cushioning part has the shape of a capital C.

17. A device according to claim 4, characterized in that the outside of the cushioning part is slightly sloping.

18. A device according to claim 4, characterized in that the inside of the cushioning part is concave.
